(19) United States
(12) Patent Application Publication
(10) Pub. No.: US 2020/0162005 A1
(43) Pub. Date: May 21, 2020

(54) PARTIAL-LOAD PHASE DEACTIVATION OF POLYPHASE ELECTRIC MACHINE

(71) Applicant: GM Global Technology Operations LLC, Detroit, MI (US)

(72) Inventors: Alireza Fatemi, Canton, MI (US); Derek F. Lahr, Howell, MI (US)

(73) Assignee: GM Global Technology Operations LLC, Detroit, MI (US)

(21) Appl. No.: 16/195,101

(22) Filed: Nov. 19, 2018

(51) Int. Cl. H02P 23/02; H02P 23/04

(52) U.S. Cl. CPC H02P 23/02; B60K 6/40; H02P 23/04

(57) ABSTRACT

An electrical system includes a multi-level traction power inverter module (TPIM), a polyphase electric machine, and a controller. The TPIM has multiple switching sets collectively operable for inverting a DC voltage on a DC voltage bus into an AC voltage on an AC voltage bus. The electric machine has (m) multiple electrical phases. Each of the (m) multiple electrical phases is connected to and driven by a respective one of the switching sets of the TPIM. The controller determines when the electric machine enters a predetermined partial-load region of operation, and, responsive to entry into the predetermined partial-load region, selectively deactivates a predetermined number (n) of the (m) multiple electrical phases. This is done via switching state signals to corresponding ones of the switching sets, with n≤m−2.

### INTRODUCTION

Electric powertrains, power plants, and other systems employ high-voltage electrical systems providing voltage levels well in excess of 12-volt auxiliary levels. When used as part of an electric drive system, for instance, a high-voltage bus may supply 60-300 volts or more to an electric traction motor. A direct current (DC)-side of such a high-voltage bus could be connected to a rectifier system, or to a rechargeable energy storage system (RESS) containing a battery pack having an application-specific number of high-energy battery cells along with associated thermal regulation hardware and other power electronics.

When using a polyphase electric machine as part of an electrical system, a power inverter module is interposed between the RESS and the electric machine. Pulse-width modulation, pulse-density modulation, or other common switching control techniques are used to establish respective on/off conducting states of the individual semiconductor switches of the power inverter module. In this manner, phase leads of the electric machine are supplied with an alternating current (AC) voltage when the electric machine operates in its capacity as a motor. The power inverter module is also operable for converting an AC output voltage from the electric machine, operating in this instance as a generator, into a DC voltage suitable for charging the battery cells of the RESS. Thus, more or less electrical current is typically pushed through the collective phase windings as needed depending on the motor torque that is requested from the electric machine.

### SUMMARY

High-voltage electric drive systems having polyphase electric machine and power inverter modules of the type noted generally above tend to have lower efficiencies when operated under partial-load conditions relative to operation under full-load conditions. “Partial-load conditions” may be thought of as the collective set of torque operating points of the electric machine that are substantially less than the electric machine's available torque capacity. Thus, “full-load conditions” may be experienced at the electrical equivalent of wide-open throttle, i.e., when substantially all of the electric machine's available torque capacity is required to meet an instantaneous requested torque operating point. For instance, an electrified vehicle may operate under full-load conditions when accelerating quickly from a standstill or while passing another vehicle on a highway.

An illustrative example application is that of an electric drive system of a vehicle, which operates under normal drive conditions, for example during commuting or stop-and-go urban driving. Under such conditions, the requested torque may be but a small fraction of the electric machine's total torque capability or rated torque. Much of the time, the requested torque may be as little as 20 percent or less of the rated torque. The majority of the electric machine's life is therefore spent operating in “lossy” partial-load regions. The disclosed strategy may therefore be used to increase efficiency under such partial-load operating conditions.

In particular, the disclosure pertains to a method for selectively deactivating some of the available electrical phases of a polyphase electric machine responsive to entering a predetermined partial-load region of the electric machine. Prevalent electrical losses under partial-load conditions are (I) copper and core losses within the respective windings and magnetic structure of the electric machine itself, and (II) switching and conduction losses occurring within the switching and circuitry components of the power inverter module. Therefore, ratios of such losses may be predetermined for the electric machine offline as a calibrated set of partial-load regions, each of which is associated with corresponding torque-speed operating points of the electric machine. Responsive to a real-time determination that the electric machine is operating in one of the pre-identified partial-load regions, the controller may disable up to all but two of the available electrical phases of the electric machine.

In an example embodiment, the electrical system includes a rechargeable energy storage system (RESS) connected to a high-voltage bus. The electrical system includes a traction power inverter module (TPIM), a polyphase electric machine, and a controller configured to selectively deactivate some of the available phases of the electric machine responsive to entering a predetermined partial-load region. In a two-level arrangement of the TPIM, the TPIM contains multiple switching sets, e.g., IGBTs, MOSFETs, or other semiconductor switches, with each switching set in an example two-tier inverter topology having an upper switch and a lower switch. As will be understood in the art of power inverter controls, the upper and lower switches of a given switching pair are connected to each other and to respective positive and negative bus rails of the high-voltage bus. Alternative multi-level TPIMs, such as neutral point clamped (NPC) inverters, cascaded h-bridge inverters, flying capacitor inverters, or other power converter configurations, have more than two switches per phase. Such inverter topologies are also usable within the scope of the present control strategy, and therefore the term “switching pair” is used interchangeably with the term “switching set” when referencing an example two-tier TPIM, with “switching set” possibly encompassing three or more switches.

For a two-level inverter in particular, an available phase multiple (m) of the electric machine equals the number of switching pairs, with an exemplary and non-limiting six-phase embodiment (m=6) used herein to illustrate the present control strategy. The controller in this embodiment is configured to determine when the electric machine enters or has entered a predetermined partial-load region of operation, and, responsive to entry into the predetermined partial-load region, to selectively deactivate a predetermined number (n) of the (m) electrical phases. Deactivation is accomplished via transmission of individual switching state signals to corresponding switches of the (n) deactivated switching pairs, with n≤m−2.

In some embodiments,

$$n = \frac{m}{2} ,$$

i.e., exactly half of the (m) available phases are deactivated, where m is an even number.

The controller may be programmed with a lookup table of electrical losses indexed by a corresponding speed and a torque point of the electric machine, and to determine when the electric machine enters the partial-load region of operation by comparing data from the lookup table to a calibrated threshold value. Optionally, the electrical losses may be a ratio of core losses to copper losses of the electric machine, or a ratio of switching losses to conductive losses of the TPIM.

In another optional configuration, the controller may be configured to receive a mode selection signal indicative of a requested deactivation ramp-in rate. Responsive to receipt of the mode selection signal, the controller ramps-in deactivation of the (n) electrical phases at the requested deactivation ramp-in rate.

When

$$n \neq \frac{m}{2} ,$$

the controller may automatically reference a deactivation schedule to determine an order of deactivation of the (n) electrical phases which minimizes a deactivation-based torque ripple of the electric machine.

The polyphase electric machine includes a rotor, which in certain disclosed embodiments is coupled to a set of drive wheels of a motor vehicle, or to another driven load.

Also disclosed is a method for use with the above-noted electrical system. The method includes determining, via the controller, when the electric machine enters a predetermined partial-load region of operation. Responsive to entry of the electric machine into the predetermined partial-load region of operation, the method includes selectively deactivating a predetermined number (n) of the (m) electrical phases via transmission of switching state signals from the controller to corresponding ones of the switching sets, wherein n≤m−2.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the appended claims.

### BRIEF DESCRIPTION OF THE DRAWINGS

FIG. 1 is a schematic illustration of an example vehicle having an electrical system in which a controller selectively deactivates (n) electrical phases of an electric machine having a total number (m) of such electrical phases, with the controller doing so under predetermined partial-load conditions as described herein.

FIGS. 2A and 2B are schematic illustrations of an exemplary 6-phase embodiment of a polyphase electric machine and traction power inverter module usable as parts of the example electrical system shown in FIG. 1.

FIG. 3 is a normalized plot of machine speed (horizontal axis) versus machine torque (vertical axis) illustrating a representative loss region within which the controller may deactivate selected phases of the electric machine shown in FIG. 1.

FIG. 4 is a normalized plot of machine speed (horizontal axis) versus machine torque (vertical axis) illustrating another representative loss region within which the controller may deactivate selected phases of the electric machine shown in FIG. 1.

FIG. 5 is a flow chart of an example embodiment of the present method.

The present disclosure may be modified or have alternative forms, with representative embodiments shown by way of example in the drawings and described in detail below. Inventive aspects of the disclosure are not limited to the particular forms as disclosed herein. Rather, the present disclosure is intended to cover modifications, equivalents, combinations, and alternatives falling within the scope of the disclosure as defined by the appended claims.

### DETAILED DESCRIPTION

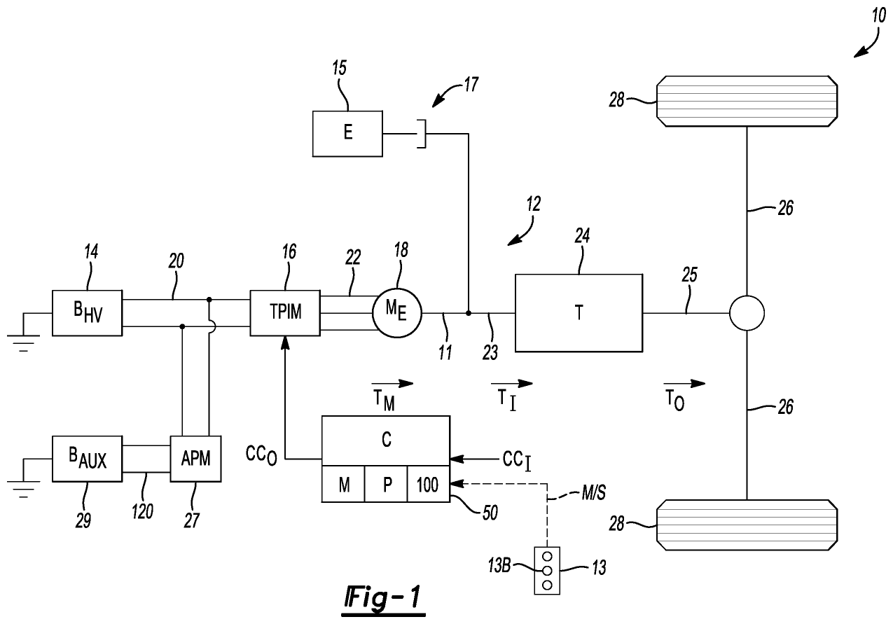

Referring to the drawings, wherein like reference numbers refer to like components, FIG. 1 depicts an example vehicle 10 having an electrical system 12. The electrical system 12 includes a high-voltage battery pack (BO 14 that is electrically connected to a multi-tier traction power inverter module (TPIM) 16 via a high-voltage direct-current (DC) bus 20. The electrical system 12 also includes a polyphase electric machine (ME) 18, e.g., a traction motor or motor/generator unit, which is electrically connected to the TPIM 16 via a high-voltage alternating-current (AC) voltage bus 22. A separate low-voltage DC bus 120 may connect an auxiliary/12-volt battery (B_{AUX}) 29 to an auxiliary power module (APM) 27 in the form of a DC-DC voltage converter, with the APM 27 in turn connected to the high-voltage DC bus 20 and configured to reduce voltage levels on the high-voltage DC bus 20 to levels suitable for powering low-voltage auxiliary functions.

The vehicle 10 includes a controller 50 which, as shown schematically in FIG. 1, may be optionally embodied as one or more low-voltage digital computers having a processor (P), e.g., a microprocessor or central processing unit, as well as memory (M) in the form of read only memory, random access memory, electrically-programmable read only memory, etc. Also included in the structure of the controller 50 but not separately illustrated is a high-speed clock, analog-to-digital and digital-to-analog circuitry, input/output circuitry and devices, and appropriate signal conditioning and buffering circuitry.

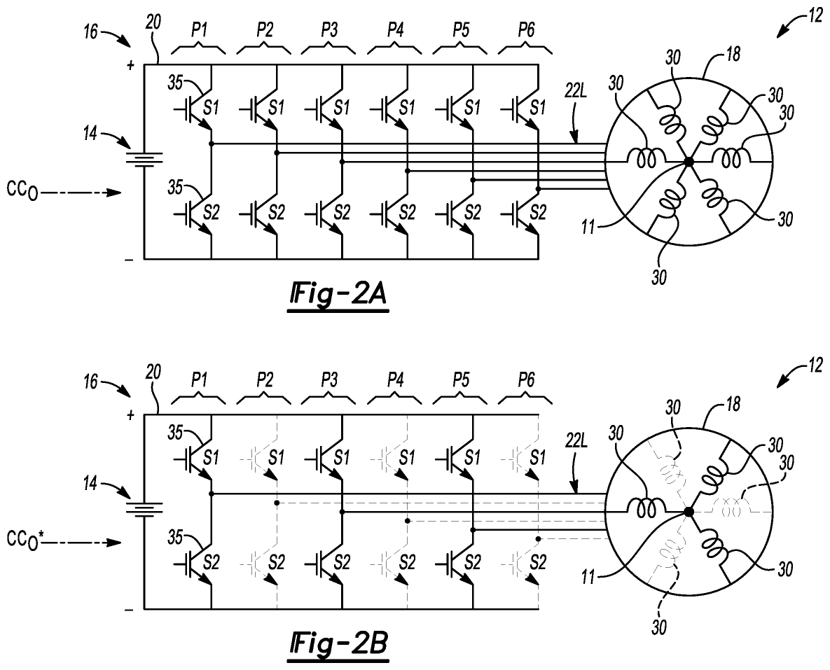

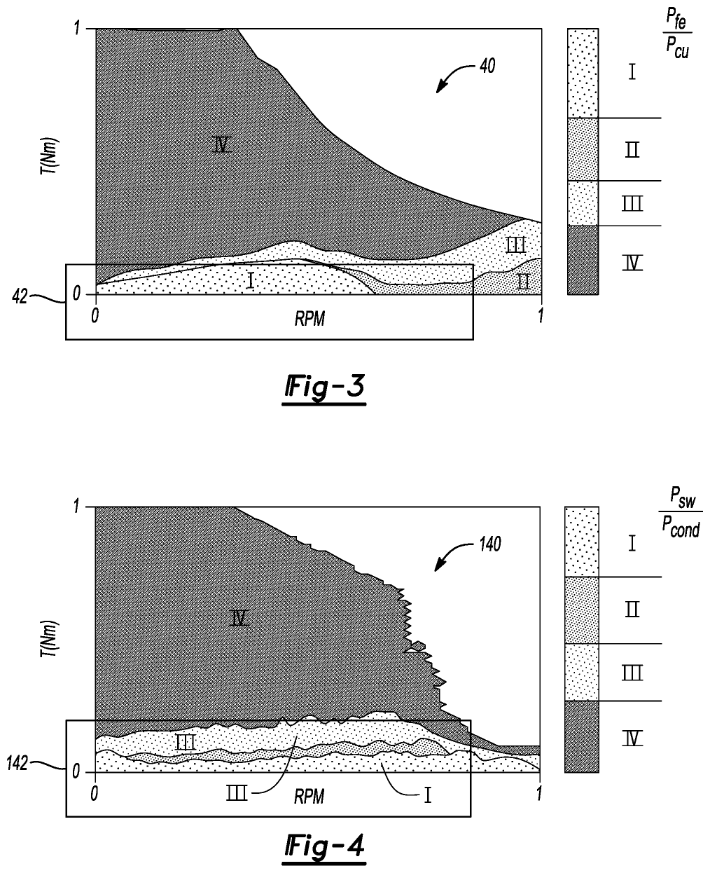

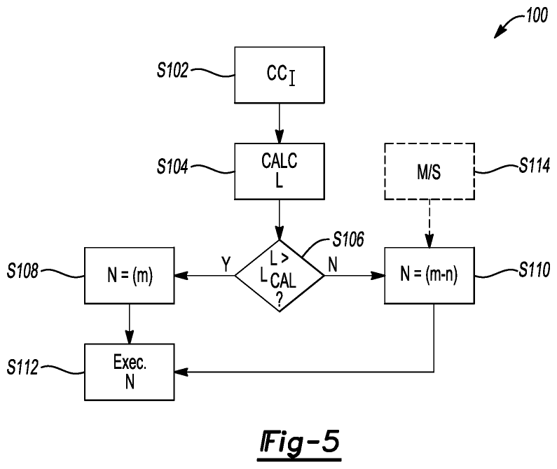

The controller 50 is programmed to execute a method 100 in response to a set of input signals (CC_{I}). An example of method 100 is shown in FIG. 5 and described below with further reference to FIGS. 3 and 4. Execution of instructions embodying the method 100 causes the controller 50 to selectively disable some of the available electrical phases of the electric machine 18. The controller 50 does this by transmitting switching control signals (arrow CC_{O}) to the TPIM 16. As described in detail below with reference to FIGS. 2A and 2B, the TPIM 16 responds to such switching control signals (arrow CC_{O}) by deactivating some of, and up to all but two of, the available electrical phases during partial-load conditions of the electric machine 18. Electrical losses ordinarily experienced under such conditions are therefore reduced, with an associated improvement in overall drive efficiency. An external device 13, e.g., a touch-screen display or a manual selection device having corresponding electronic or mechanical mode settings 13B, may optionally generate a trigger signal in the form of a mode selection signal (arrow M/S) as explained below with reference to FIG. 5. The controller 50 may be configured to receive such a mode selection signal, possibly as part of the control signals of FIG. 1 or as a separate signal, with the mode

When the electric machine 18 is used as part of the example vehicle 10, for instance to generate and deliver motor torque (arrow T_{M}) to an input member 23 of a transmission (T) 24 for propulsion of the vehicle 10, the voltage level on the high-voltage DC bus 20 and the AC voltage bus 22 may exceed 60-volts, and may be over 300-volts depending on the configuration of the vehicle 10. Thus, the term “high-voltage” as used herein is application-specific, but in general extends to voltage levels in excess of 12-volt auxiliary levels on the DC bus 120. Optionally, the vehicle 10 may include an internal combustion engine (E) 15 that is selectively coupled to the input member 23 of the transmission 24 via a clutch 17, e.g., a friction clutch or a hydrodynamic torque converter assembly. The engine 15 and/or the electric machine 18 may, depending on the operating mode, generate and deliver an input torque (arrow T_{I}) to the transmission 24. The transmission 24 delivers output torque (arrow T_{O}) to an output member 25.

When the vehicle 10 is a motor vehicle as depicted, a set of drive axles 26 may be coupled to a driven load in the form of a set of drive wheels 28, each of which is in rolling frictional contact with a road surface (not shown). In other vehicular embodiments, the driven load may be a wheel of a rail vehicle, or a propeller shaft of an aircraft or marine vessel. Likewise, non-vehicular embodiments such as power plants or to power pumps or hoists, e.g., in support of water removal or lode extraction in mining operations, and therefore such embodiments may similarly benefit from the present teachings. Thus, the vehicle 10 of FIG. 1 is intended to be illustrative of a type of system that may benefit from the method 100 without limitation.

The TPIM 16 shown in FIG. 1 is depicted in more detail in FIGS. 2A and 2B. FIG. 2A shows the TPIM 16 in a first state in which all available electrical phases of the electric machine 18 are active. FIG. 2B illustrates the TPIM 16 in a second state in which half of the available electrical phases are deactivated, with the signals CC_{O} of FIG. 2A thus modified to signals CC_{O*}. Additionally, the electric machine 18 is represented in a non-limiting example embodiment as having six phases, each of which is 60° out-of-phase with respect to a next adjacent phase. Other polyphase embodiments may be used within the scope of the disclosure, however, such as three-phase, four-phase, five-phase, etc., and with more than the six illustrated phases of FIGS. 2A and 2B used in other embodiments.

Regardless of the total number of available electrical phases of the electric machine 18, the present approach may provide another control degree of freedom in addition to, e.g., control of the phase angle and current or voltage amplitude. The method 100 may be advantageously applied to electric machines 18 having different winding technologies or rotor types. Particular benefits may be enjoyed in machine configurations lacking a rotor field or having a controllable rotor field, such as switch reluctance machines, wound-field synchronous machines, and synchronous reluctance machines. Likewise, the electric machine 18 will ideally have magnetically-isolated windings such that the described phase deactivation according to the method 100 results in unexcited core segments, as will be appreciated by those of ordinary skill in the art.

The TPIM 16 of FIGS. 2A and 2B, when configured as a two-tier TPIM as shown for use with the example six-phase embodiment of the electric machine 18, has six switching pairs P1, P2, P3, P4, P5, and P6 that are collectively operable for inverting a DC voltage on the DC voltage bus 20 into an AC voltage on the AC voltage bus 22, and vice versa, via the switching control signals (arrow CC_{O}). That is, each switching pair includes identical switches 35, shown as representative semiconductor switches S1 and S2, respectively, e.g., IGBTs as shown, MOSFETs, or other suitable semiconductor or solid-state switches.

In its various configurations, the electric machine 18 has a plurality (m) of available electrical phases, with m=6 in FIGS. 2A and 2B. Each of the (m) available electrical phases is shown structurally as individual phase leads 22L corresponding to the AC voltage bus 22 of FIG. 1, with the phase leads 22L feeding corresponding stator windings 30 of the electric machine 18. Thus, each of the phase leads 22L is connected/electrically driven by a respective switching set, in this instance a switching pair P1, P2, P3, P4, P5, or P6 of the example two-tier or two-level TPIM 16. When one of the (m) available electrical phases is energized, or when multiple phases are energized according to a particular control sequence, a desired rotation of a rotor shaft 11 may be realized.

When executing the method 100, the controller 50 shown in FIG. 1 determines when the electric machine 18 has entered or will soon enter a predetermined partial-load region of operation. Example regions 42 and 142 are described below with reference to FIGS. 3 and 4, respectively. Responsive to entry into the predetermined partial-load region, the controller 50 selectively deactivates a predetermined number (n) of the (m) available electrical phases of the electric machine 18. Such a control action is effectuated via transmission of the switching state signals (arrow CC_{O}) to corresponding ones of the switches 35 of switching pairs P1, P2, P3, P4, P5, and/or P6. For practical purposes, the number of deactivated phases (n) is less than or equal to the total number of phases (m) minus two, i.e., n≤m−2.

Deactivation of exactly half of the (m) available phases may be beneficial in terms of the resultant torque quality. That is, when an even number of electrical phases is presented, i.e., m=4, 6, 8, 10, etc., a reduction in perceived torque ripple or other noise, vibration, and harshness effect may be enjoyed when

$$n = \frac{m}{2} .$$

However, other values of (n) may be used to provide efficiency gains under partial-load operating conditions, with m being even or odd without limitation. As few as one deactivated phase, i.e., n=1, may therefore fall within the scope of the present disclosure. The sequence of deactivation should take into consideration the spatial distribution of the stator windings 30 of the electric machine 18, with the quality of the resultant torque about the rotor 11 being a function of the timing of phase deactivation and identity/relative position of the (n) deactivated phases.

Electromagnetic power losses occurring in the electric machine 18 consist of core losses (P_{fe}) and copper losses (P_{cu}), i.e., P₁₈=P_{fe} P_{cu}. Power losses in the TPIM 16 (P₁₆) mainly consist of switching losses (P_{sw}) and conduction losses (P_{cond}), i.e., P₁₆=P_{sw} P_{cond}. These four prevalent categories of power losses may be quantified off-line and recorded in memory (M) of the controller 50, and thereafter used as lookup tables or performance curves when detecting partial-load regions 42 or 142 in which to selectively deactivate some of the available phases.

FIGS. 3 and 4 respectively illustrate two example loss regions 40 and 140 during operation of the electric machine 18 of FIGS. 1-2B, with rotary speed (RPM) of the electric machine 18 depicted on the horizontal axis and torque, T(Nm), depicted on the vertical axis. For illustrative simplicity, the scale of FIGS. 3 and 4 has been normalized to range from 0 to 1. In an example propulsion embodiment of the electric machine 18, however, the rotary speed may be on a scale of zero to several thousand RPM and torque may be on scale of zero to several hundred Nm, with other applications having corresponding scales.

Depicted loss regions I, II, III, and IV are indicative of decreasing power losses in terms of a predefined loss ratio, i.e.,

$$\frac{{P}_{fe}}{{P}_{cu}}$$

### in FIG. 3 and

$$\frac{{P}_{sw}}{{P}_{cond}}$$

in FIG. 4. The partial-load regions 42 and 142 may likewise be predefined, e.g., stored in a lookup table, and used by the controller 50 in real-time based on actual torque and speed of the electric machine 18 to determine precisely when to deactivate electrical phases according to the method 100.

As will be appreciated, the vast majority of torque-speed operating points of the electric machine 18 will occur at substantially less than the rated torque of the electric machine 18, such as 20 percent or less of the rated torque. As a result, partial-load operating conditions may account for over 95 percent of the electromagnetic losses in the electric machine 18 and inverter losses in the TPIM 16, with power losses in the electric machine 18 generally being at least twice the amount of inverter losses in the TPIM 16. Core losses are several times higher than copper losses over a majority of operating points, as seen in FIG. 3 relative to FIG. 4. The method 100 may therefore identify regions in which core losses are much higher than copper losses, e.g., 10 times higher as shown in FIG. 3, and thereafter use corresponding torque-speed points to detect whether the electric machine 18 is presently operating in such a zone or will imminently enter such a zone.

As an example of power loss reduction that is made possible by the present disclosure, consider an example m-phase permanent magnetic motor as the electric machine 18 in case (1), and deactivation of (n) phases in case (2). Assuming T≈kI:

P₁=P_{fe,1}+P_{cu,1}+P_{sw,1}+P_{cond,1}

P₂=P_{fe,2}+P_{cu,2}+P_{sw,2}+P_{cond,2}

Simplified inverter conduction losses and motor copper losses increase by a factor of

$$\frac{m}{( m - n )} .$$

Simplified inverter switching losses at low currents (I) remain unchanged. Furthermore, assuming that motor iron losses (P_{fe}) also decrease by a factor of k when n phases are deactivated:

$${P}_{2} = k {P}_{fe , 1} {P}_{sw , 1} + \frac{m}{( m - n )} ( {P}_{cu , 1} + {P}_{cond , 1} )$$

The losses encompassed by term kP_{fe,1}+P_{sw,1} are higher at partial loads, while the losses represented by the sum (P_{cu,1}+P_{cond,1}) are higher at full loads. Thus, to some extent the deactivation of (n) phases comes with a tradeoff in the form of increased copper losses. However, as the greatest amount of loss under a partial load occurs in the core, i.e., P_{fe}, the reduction of such core losses under partial-load conditions is enjoyed by reducing the number of active phases in such a region.

The loss disparity may be illustrated as follows. Assuming P_{fe,1} 10P_{cu,1}, and that P_{sw,1}=10P_{cond,1} at partial load, the controller 50 may disable n=3 phases in an example six-phase embodiment of the electric machine 18 where m=6. In such an embodiment:

P₁=P_{fe,1}+P_{cu,1}+P_{sw,1}+P_{cond,1}=11P_{cu,1}+11P_{cond,1}

P₂=P_{fe,2}+P_{cu,2}+P_{sw,2}+P_{cond,2}=kP_{fe,1}+2P_{cu,1}+P_{sw}

→P₂=(10k+2)P_{cu,1}+12P_{cond,1}

For k=0.5, for instance, a 36% power loss reduction in the electric machine 18 is possible relative to a 9% increase in losses for the TPIM 16. Assuming that overall motor losses are 2× or 200% of inverter losses, this will result in a 21% system power loss reduction. Avoidance of such losses may be enabled by execution of the method 100.

An example embodiment of the method 100 is shown in FIG. 5. Commencing at step S102, the controller 50 receives the set of input signals (CO noted above with reference to FIG. 1. The input signals (CC_{I}) may include, for instance, a measured or calculated actual and desired speed and torque of the electric machine 18. Such values may be derived in real-time by the controller 50 from a driver's requested torque, e.g., using values such as accelerator pedal travel/throttle, braking levels, steering input, etc. In an optional hybrid electric vehicle embodiment, requested torque may be apportioned in logic between engine torque from the engine 15 and the motor torque (arrow T_{M}) from the electric machine 18. The method 100 then proceeds to step S104.

At step S104, the controller 50 determines a corresponding torque operating region of the electric machine 18. As part of step S104, the controller 50 may use torque and speed point values from step S102 to determine whether the electric machine 18 is working within a permissible range of its calibrated maximum rated torque for that particular speed and operating temperature. The method 100 then proceeds to step S106.

Step S106 includes comparing the torque or load on the electric machine 18 from step S104 to a calibrated threshold indicative of partial-load conditions. As noted above, torque and speed points may be associated with a loss ratio of electromagnetic losses, such as iron/core-to-copper losses as depicted in FIG. 3. The calibrated threshold may be defined as an operating region of multiple operating points, e.g., zones 42 or 142 of FIGS. 3 and 4. The method 100 proceeds to step S108 when the electric machine 18 operates or will soon operate under full-load conditions, i.e., above the threshold or outside of a predefined partial-load operating zone 42 or 142, and to step S110 in the alternative when the controller 50 instead determines that the electric machine 18 is operating under partial-load conditions.

Step S108 of method 100 as shown in FIG. 5 includes commanding the full number (m) of available electrical phases of the TPIM 16 of FIGS. 1, 2A, and 2B to turn or remain in an on/conducting state. Pulse-width modulation, pulse-density modulation, or other suitable switching signals continue to be transmitted to the switches 35 of FIG. 2A, which results in digital pulses of various sizes or durations being closely coordinated by the controller 50 to ensure the desired rotation of the electric machine 18. That is, the state of the (m) electrical phases shown as active in FIG. 2A does not preclude on/off switching control to vary the output voltage of the TPIM 16, and thus the various switches 35 of the TPIM 16 may or may not conduct at a given instant while remaining “available phases” in the switching control circuit of FIG. 2A. The method 100 then proceeds to step S112.

Step S110, in contrast, deactivates (n) of the available (m) phases and then proceeds to step S112. Once deactivated, the switches 35 for the deactivated (n) phases are no longer available in the switching control circuit, akin to a sustained binary 0/off signal to the switches 35. PWM or other switching control signals used to vary the output voltage of the TPIM 16 in FIG. 2B are thus restricted to real-time switching control using the (m−n) active electrical phases, with the (n) deactivated phases being effectively non-existent from the standpoint of the electric machine 18. Thus, relative to approaches that evenly reduce the amount of current flowing through the (m) available electrical phases to change the motor torque or speed, the present method 100 need not reduce current flow through the (m−n) active phases.

At step S112, the controller 50 controls the output torque or speed of the electric machine 18 using N phases, with N=m if step S112 is arrived at from step S108 and N=(m−n) if step S112 is instead arrived at from step S110.

Optionally, the method 100 may include step S114 to enable use of a trigger signal in the form of a mode selection signal (M/S). The mode selection signal (M/S) may be transmitted by the external device 13 of FIG. 1, e.g., a touch-sensitive display screen or a mechanical push-type button, knob, or other mechanical or electromechanical mode selection mechanism of the vehicle 10 of FIG. 1. The controller 50 may be configured to receive such a mode selection signal (M/S), possibly as part of the control signals of FIG. 1 or as a separate signal, with the mode selection signal (M/S) being indicative of a requested deactivation ramp-in rate.

Responsive to receipt of the mode selection signal, the controller 50 may ramp in the deactivation of the (n) electrical phases at the requested deactivation ramp-in rate. Such an approach may allow an operator of the vehicle 10 to customize torque feel when deactivating the (n) phases, for instance as an economy (energy-efficient), sport (faster torque response), or normal operating mode, with normal possibly balancing torque responsiveness with energy efficiency, e.g., using a cost function. Or, the controller 50 may automatically reference a phase deactivation schedule to determine an order of deactivation of the (n) phases, particularly when

$$n \neq \frac{m}{2} ,$$

so as to minimizes deactivation-based torque ripple along a driveline of the vehicle 10 caused by such phase deactivation.

Therefore, the method 100 as described above provides a strategy for reducing losses in multi-phase electric machines such as the example electric machine 18 of FIG. 1. Loss reduction is achieved through control of the number of active phases feeding the machine's armature windings. As will be appreciated, targeted phase deactivation may enable balancing of copper and core losses in the electric machine 18 with switching and conduction losses in the TPIM 16. As the motor torque (arrow T_{M} of FIG. 1) is proportional to the number of active phases, use of the method 100 under partial-load conditions, when properly sequenced, may produce efficiency gains without compromising torque quality. These and other benefits will be readily appreciated by those of ordinary skill in the art in view of the forgoing disclosure.

While some of the best modes and other embodiments have been described in detail, various alternative designs and embodiments exist for practicing the present teachings defined in the appended claims. Those skilled in the art will recognize that modifications may be made to the disclosed embodiments without departing from the scope of the present disclosure. Moreover, the present concepts expressly include combinations and sub-combinations of the described elements and features. The detailed description and the drawings are supportive and descriptive of the present teachings, with the scope of the present teachings defined solely by the claims.

What is claimed is:

1. An electrical system comprising:
an AC voltage bus;
a DC voltage bus;
a multi-level traction power inverter module (TPIM) connected to the DC voltage bus, and having multiple switching sets collectively operable for inverting a DC voltage on the DC voltage bus into an AC voltage on the AC voltage bus, and vice versa;
a polyphase electric machine having (m) multiple electrical phases, wherein each of the (m) multiple electrical phases is connected to and driven by a respective one of the multiple switching sets; and
a controller configured to determine when the electric machine enters a predetermined partial-load region of operation, and, responsive to entry into the predetermined partial-load region, to selectively deactivate a predetermined number (n) of the (m) multiple electrical phases via switching state signals to a corresponding switching set of the multiple switching sets, wherein n≤m−2.

2. The electrical system of claim 1, wherein
$$n = \frac{m}{2} .$$

3. The electrical system of claim 1, wherein m≥4.

4. The electrical system of claim 3, wherein m=6.

5. The electrical system of claim 1, wherein individual switches comprising each of the multiple switching sets are semiconductor switches.

6. The electrical system of claim 1, wherein the controller is programmed with a lookup table of electrical losses indexed by a speed and a torque of the electric machine, and to determine when the electric machine enters the partial-load region of operation by comparing data from the lookup table to a calibrated threshold value.

7. The electrical system of claim 6, wherein the electrical losses in the lookup table of electrical losses are a ratio of core losses to copper losses of the electric machine.

8. The electrical system of claim 6, wherein the electrical losses in the lookup table of electrical losses are a ratio of switching losses to conductive losses of the multi-level TPIM.

9. The electrical system of claim 1, wherein the controller is configured to receive a mode selection signal indicative of a requested deactivation ramp-in rate, and responsive to the mode selection signal, to ramp in deactivation of the up to half of the multiple electrical phases at the requested deactivation ramp-in rate.

10. The electrical system 1, wherein the controller is configured, when n≠m/2 , to automatically reference a deactivation schedule to determine an order of deactivation of the (n) phases which minimizes deactivation-based torque ripple of the electric machine.

11. The electrical system of claim 1, wherein the polyphase electric machine includes a rotor coupled to a set of drive wheels of a motor vehicle.

12. A method for use with an electrical system having a multi-level traction power inverter module (TPIM) connected to a direct current (DC) voltage bus and a polyphase electric machine, the polyphase electric machine having (m) multiple electrical phases connected to and driven by a respective switching set of the TPIM and coupled to a driven load, the method comprising:
determining, via a controller, when the polyphase electric machine enters a predetermined partial-load region of operation; and
responsive to entry of the polyphase electric machine into the predetermined partial-load region of operation, selectively deactivating a predetermined number (n) of the (m) multiple electrical phases via transmission of switching state signals from the controller to corresponding one of the switching sets, wherein n≤m−2.

13. The method of claim 12, the method further comprising: powering the driven load via the electric machine, wherein the driven load is a set of road wheels of a motor vehicle.

14. The method of claim 12, wherein m≥4.

15. The method of claim 14, wherein m=6.

16. The method of claim 12, wherein the controller is programmed with a lookup table of electrical losses indexed by a speed and a torque of the electric machine, wherein determining when the electric machine enters the partial-load region of operation includes comparing data from the lookup table to a calibrated threshold value.

17. The method of claim 16, wherein the electrical losses in the lookup table of electrical losses are a ratio of core losses to copper losses of the electric machine.

18. The method of claim 16, wherein the electrical losses in the lookup table of electrical losses are a ratio of switching losses to conductive losses of the TPIM.

19. The method of claim 12, the method further comprising:
receiving, via the controller from an external device, a mode selection signal indicative of a requested deactivation ramp-in rate; and
responsive to receipt of the mode selection signal, ramping in a deactivation of the predetermined number (n) of the (m) multiple electrical phases at the requested deactivation ramp-in rate.

20. The method of claim 12, the method further comprising:
when
$$n \neq \frac{m}{2} ,$$
automatically referencing a deactivation schedule to determine an order of deactivation of the (n) phases which minimizes deactivation-based torque ripple of the electric machine.
